(19) United States
(12) Patent Application Publication
(10) Pub. No.: US 2008/0135754 A1
(43) Pub. Date: Jun. 12, 2008

(54) Charged-Particle Beam System

(75) Inventor: Yoshiyuki Eto, Kanagawa (JP)

Correspondence Address: THE WEBB LAW FIRM, P.C., 700 KOPPERS BUILDING, 436 SEVENTH AVENUE, PITTSBURGH, PA, 15219, US

(73) Assignee: JEOL LTD., Tokyo (JP)

(21) Appl. No.: 11/939,121

(22) Filed: Nov. 13, 2007

(30) Foreign Application Priority Data
Dec. 6, 2006 (JP) 2006-328949

(51) Int. Cl. G21K 5/04; G01N 23/08

(52) U.S. Cl. 250/310; 250/492.22

(57) ABSTRACT

A charged-particle beam system capable of reliably detecting defects in an interconnect pattern, which is formed, for example, on a semiconductor device. The system uses an electron source for producing an electron beam. A specimen on which the interconnect pattern is formed is scanned with the electron beam in two dimensions. An image of the specimen is created based on a signal obtained from the specimen in response to the scanning, and the image is displayed on a display portion. Two probes are brought into contact with arbitrary locations on the interconnect pattern. Absorption currents obtained via the probes are applied to a differential current-voltage converter. Thus, the difference between the absorption currents is converted into a voltage signal. An absorption current image is created based on the voltage signal and displayed on the display portion.

### BACKGROUND OF THE INVENTION

1. Field of the Invention

The present invention relates to a charged-particle beam system capable of identifying defective portions of a specimen.

2. Description of Related Art

Emission microscopes are used in failure analysis of semiconductor devices. However, in some cases, the physical position of a defective portion may not be directly identified because of insufficient resolution. Furthermore, in recent years, conductive interconnects in semiconductor devices have been made finer and so it has become difficult to identify defective portions with the above-described emission microscopes.

In recent years, a charged-particle beam system for performing failure analysis of a semiconductor device by irradiating the surface of the device with a charged-particle beam, detecting the electrical current absorbed into the interconnect pattern, and imaging the detected current has attracted attention.

FIG. 7 shows one example of the configuration of such a charged-particle beam system. The system has a specimen stage 5 on which a specimen 4 is placed. An interconnect pattern 3 is formed in the specimen 4. Probes 2A and 2B are in contact with the opposite ends of the pattern 3 at their respective one ends. The other end of one probe 2A is grounded. The other end of the other probe 2B is connected with a current-voltage converter 30. This converter 30 consists of an operational amplifier 27 and a feedback resistor 29. The output from the converter 30 is amplified by a voltage amplifier circuit 24. An electrical current image created based on the output from the voltage amplifier circuit 24 is displayed on a display portion 7.

In the charged-particle beam system designed in this way, if a primary electron beam 1 is scanned over the specimen 4 in two dimensions, an absorption current corresponding to the electron beam absorbed by the interconnect pattern 3 flows into the probes 2A and 2B. Because the absorption current flows through the resistor 29 via the probe 2B, the current-voltage converter 30 produces an output voltage corresponding to the absorption current.

This voltage signal is amplified by the voltage amplifier circuit 24 and sent to the display portion 7 in synchronism with the two-dimensional scanning. As a result, an absorption current image of the interconnect pattern 3 is displayed on the display portion 7. At this time, if the interconnect pattern has a defect, the manner in which the absorption current flows across the defect varies. Consequently, the contrast varies across the part of the absorption current image that represents the defective portion. Hence, it is possible to detect the defective portion.

A secondary electron detector (not shown) is mounted separately to detect secondary electrons. A specimen image 8 created based on the output signal from the secondary electron detector is displayed on the display portion 7 in an overlapping manner with the absorption current image. The operator can identify the defective portion of the interconnect pattern 3 by observing the absorption current image and specimen image 8.

In the system shown in FIG. 7, if the resistance of the interconnect pattern is small, e.g., the resistance of the pattern is lower than the input resistance of the current-voltage converter 30, all the absorption current flows to the grounded portion from the probe 2A. As a result, no detection output is obtained. Hence, there is the problem that it is impossible to identify the defective portion in the interconnect pattern.

### SUMMARY OF THE INVENTION

It is an object of the present invention to provide a charged-particle beam system capable of detecting interconnect defects reliably.

A charged-particle beam system according to one embodiment of the present invention displays an image of a specimen on a display device by producing a charged-particle beam from a charged-particle beam source, scanning the beam over the specimen in two dimensions, and creating the specimen image based on a signal obtained from the specimen by the scanning. The charged-particle beam system has plural probing devices and a differential current-voltage converter. The probing devices bring at least two probes into contact with arbitrary locations on the specimen. The differential current-voltage converter converts the difference of absorption current signals obtained via the probing devices into a voltage signal. A specimen image created based on the output signal from the current-voltage converter is displayed on the display device.

In the present invention, the absorption currents flowing through the first and second probes, respectively, are fed to the differential current-voltage converter. As a result, the difference between the absorption currents flowing through the first and second probes, respectively, is converted into a voltage signal. An absorption current image is created based on the voltage signal and displayed. Consequently, the contrast can be greatly accentuated across a defective portion in the interconnect pattern. As a result, the defective portion in the pattern can be detected reliably.

Other objects and features of the invention will appear in the course of the description thereof, which follows.

### BRIEF DESCRIPTION OF THE DRAWINGS

FIG. 1 is a schematic representation of a charged-particle beam system according to one embodiment of the present invention;

FIG. 2 is a diagram showing an equivalent circuit of a connector portion between an interconnect pattern and a differential current-voltage converter;

FIGS. 3A, 3B and 3C show graphs of absorption current characteristics;

FIG. 4 is a schematic representation of a charged-particle beam system according to one embodiment of the present invention, showing the whole configuration of the system;

FIGS. 5A and 5B show a secondary electron image and an absorption current image which are displayed at the same time;

FIG. 6 is a schematic representation of main portions of a charged-particle beam system according to another embodiment of the present invention; and

FIG. 7 is a schematic representation of a prior art charged-particle beam system.

### DETAILED DESCRIPTION OF THE INVENTION

Embodiments of the present invention are hereinafter described in detail with reference to the drawings.

### First Embodiment

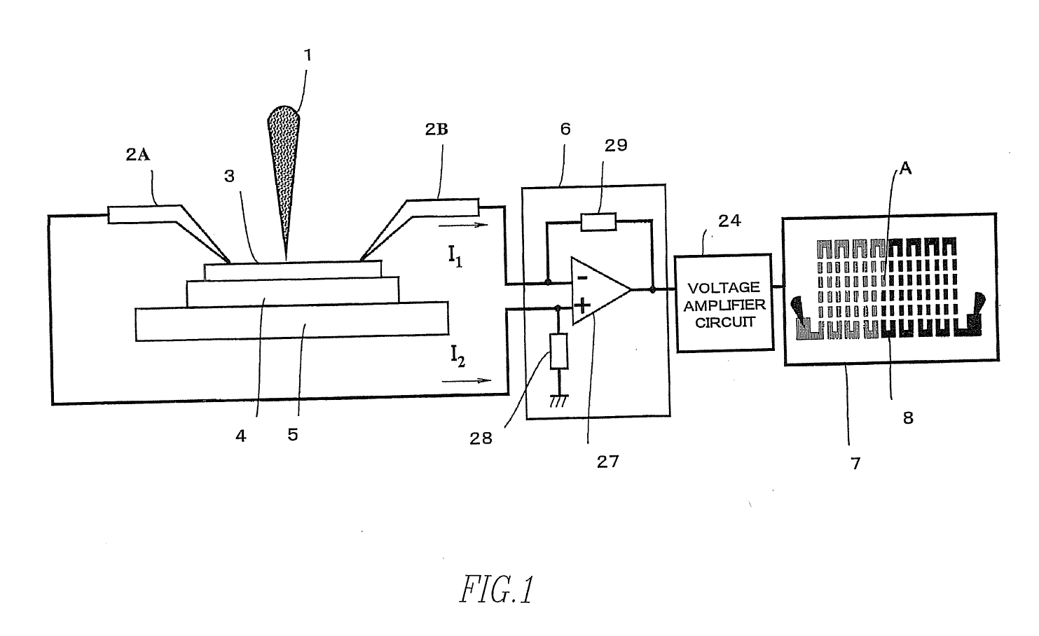

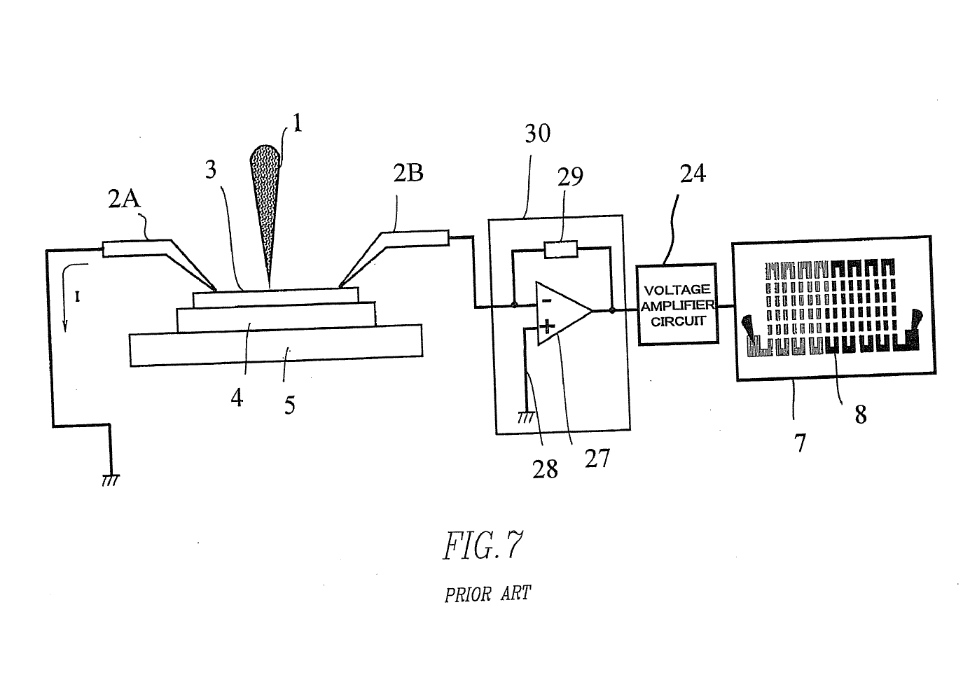

FIG. 1 is a schematic representation of a charged-particle beam system according to one embodiment of the present invention. Those components of FIG. 1 which are identical with their counterparts of FIG. 7 are indicated by the same reference numerals as in FIG. 7.

In FIG. 1, probes 2A and 2B are in contact with the opposite ends of an interconnect pattern 3 at their respective one ends, the pattern 3 being formed on a specimen 4. The other ends of the probes 2A and 2B are connected with a differential current-voltage converter 6. The converter 6 is made up of the operational amplifier 27, feedback resistor 29, and another resistor 28. The other end of the probe 2A is connected with the positive input terminal of the operational amplifier 27. The other end of the probe 2B is connected with the negative input terminal of the operational amplifier 27. The resistor 28 is connected between the positive input terminal of the amplifier 27 and ground.

In the operation of the system constructed in this way, the surface of the specimen 4 is scanned in two dimensions with a primary electron beam 1. Because of the scanning, an absorption current corresponding to an electron beam absorbed by the interconnect pattern flows through the interconnect pattern 3 formed on the specimen 4. The absorption current is detected by the probes 2A and 2B. The resulting signals are sent to the positive and negative input terminals of the differential current-voltage converter 6. The converter converts the differential current between the detected currents into a voltage, which, in turn, is fed to a voltage amplifier circuit 24.

Let I₁ be the electrical current flowing through the probe 2B. Let I₂ be the electrical current flowing through the probe 2A. Let R be the resistance value of the feedback resistor 29 for the current-voltage converter 6 and of the resistor 28. Let V₁ be the voltage at the input of the operational amplifier 27. Let Vₒ be the output voltage from the amplifier 27. Assuming that the voltage at the positive input terminal of the operational amplifier 27 and the voltage at the negative input terminal are the same, the current I₁ flowing through the probe 2B is given by

$${I}_{1} = \frac{{V}_{1} - {V}_{0}}{R}$$

Meanwhile, a relationship V₁=R·I₂ holds. Substituting the voltage V₁ into the above equation gives rise to:

R·I₁=R·I₂−V₀.

### Therefore, the output is given by

V₀=R(I₂−I₁)

The output from the differential current-voltage converter 6 is fed to a controller (not shown) via the voltage amplifier circuit 24. In the controller, the output signal Vₒ from the converter 6 which corresponds to the difference between the currents flowing through the probes 2B and 2A, respectively, is converted into an image signal in synchronism with the two-dimensional scanning of the electron beam and supplied to the display portion 7. The differential signal Vₒ corresponds to a variation in the current absorbed into the interconnect pattern 3. The signal is displayed as an absorption current image of the pattern 3 on the display portion 7.

At this time, if a defective portion A having an abnormal resistance, for example, is present in a signal path within the interconnect pattern 3, the manner in which the electrical current is absorbed into the pattern 3 varies across the defective portion A. The contrast of the image clearly varies across the defective portion A in the absorption current image. Consequently, the defective portion A in the interconnect can be detected.

In this case, the coordinates of the points scanned on the display portion 7 can be recognized by the controller (not shown). Hence, the coordinates of the defective portion A can be found. That is, automatic recognition of defects is enabled.

The principle on which the electrical current flowing through the interconnect pattern 3 is amplified by the differential current-voltage converter 6 is described.

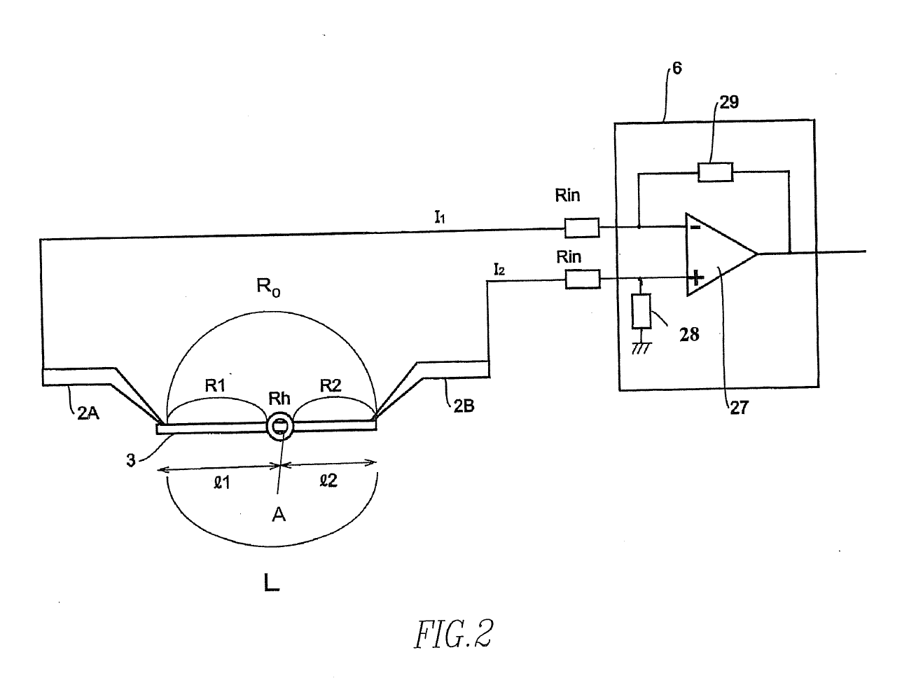

FIG. 2 is a diagram showing an equivalent circuit of a connector portion between the interconnect pattern 3 and the differential current-voltage converter 6. Those components of FIG. 2 which are identical with their counterparts of FIG. 1 are indicated by the same reference numerals as in FIG. 1.

In FIG. 2, the length of the interconnect pattern 3 is L. The defective portion A has a resistance Rh. The portion of the pattern 3 which extends from the end on the side of the probe 2A to the defective portion A has a resistance R1. The portion of the pattern 3 which extends from the deflective portion A to the end on the side of the probe 2B has a resistance R2. Each of the positive and negative input terminals of the operational amplifier 27 has an input resistance Rin. That is, it is assumed here that the positive and negative input terminals are identical in input resistance. The distance from the end of the pattern 3 on the side of the probe 2A to the defective portion A is indicated by l1. The distance from the defective portion A to the end of the pattern 3 on the side of the probe 2B is indicated by l2.

When the interconnect pattern 3 is irradiated with an electron beam, the electrical current absorbed into the pattern is indicated by Iₐ. The current Iₐ is split by the resistances on the opposite sides of the beam-irradiating portion. Let I₁ and L₂ be absorption currents flowing from the probes 2A and 2B, respectively, into the differential current-voltage converter 6 via the input resistor Rin.

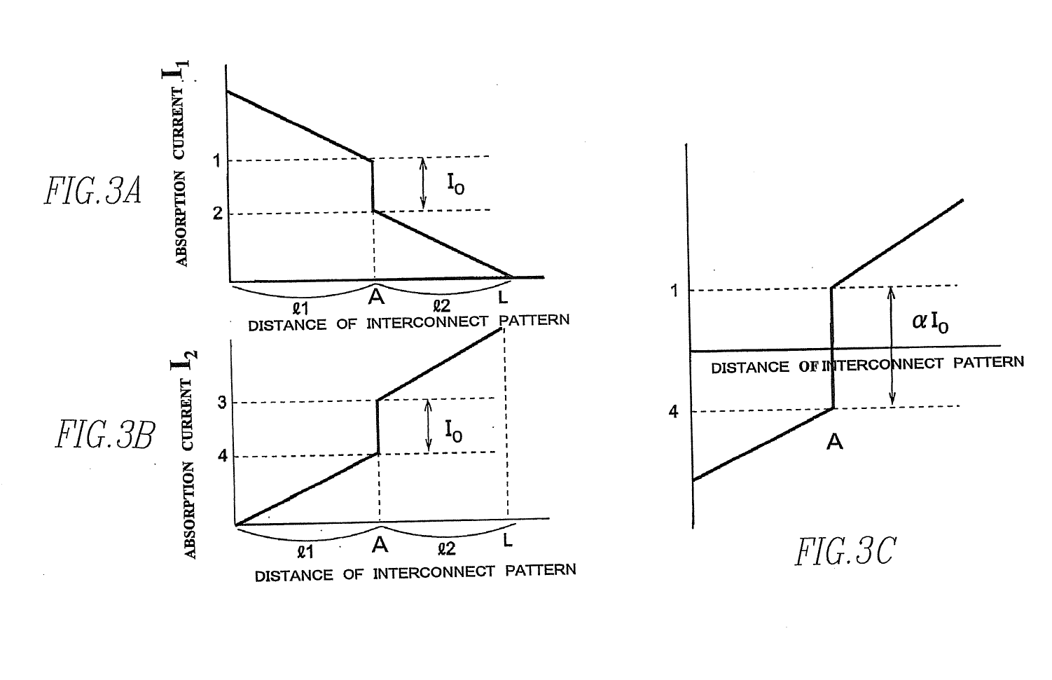

The absorption currents split in the equivalent circuit as shown in FIG. 2 have characteristics as shown in FIGS. 3A and 3B. The vertical axis indicates an absorption current. The horizontal axis indicates the distance of the interconnect pattern. A step is created across the defective portion A whether the characteristics are the characteristics of the probe 2A of FIG. 3A or the characteristics of the probe 2B of FIG. 3B. This portion corresponds to the absorption current Iₒ occurring at the defective portion.

The difference between the absorption current value shown in FIG. 3A and the absorption current value shown in FIG. 3B is taken for each value of the interconnect pattern distance. The absorption current difference is found for each value of interconnect pattern distance. The results are characteristics as shown in FIG. 3C. The characteristics correspond to the output from the differential current-voltage converter 6. The value has been magnified by a factor α (where α>1) compared with the absorption current Iₒ at the defective portion A. The α corresponds to the gain of the differential current-voltage converter 6 and is determined by the resistance R of the feedback resistor 29.

As shown in FIG. 7, in a case where one probe is connected with the current-voltage converter while the other probe is grounded, all the absorption current flows into the grounded probe if the interconnect pattern has a low resistance value as mentioned previously. No absorption current flows at all into the current detection side. Therefore, there is the problem that the defective portion cannot be identified. In contrast, in the present embodiment, absorption currents flowing into the first and second probes, respectively, are entered into the differential current-voltage converter. Consequently, the difference between the absorption currents flowing into the first and second probes, respectively, is converted into a voltage signal. A specimen image (absorption current image) is created based on the voltage signal and displayed. Hence, the contrast across the defective portion in the interconnect pattern can be accentuated greatly. As a result, the defective portion in the interconnect pattern can be detected reliably.

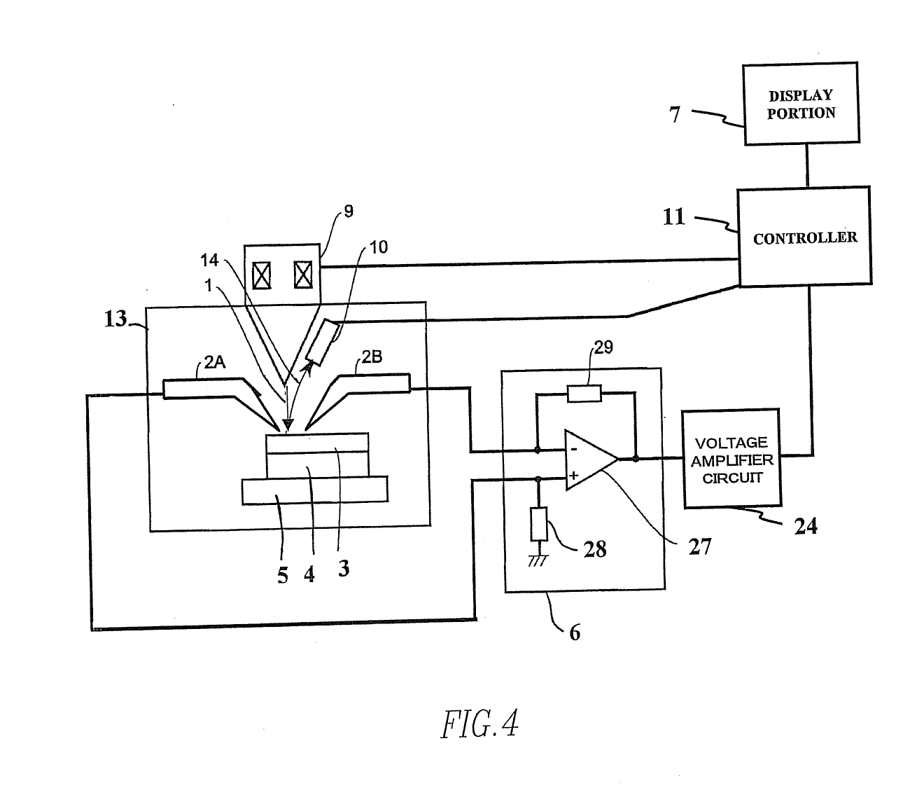

FIG. 4 shows the whole configuration of the charged-particle beam system according to the present embodiment. Those components of FIG. 4 which are identical with their counterparts of FIG. 1 are indicated by the same reference numerals as in FIG. 1.

An electron optical column 9 having a lens system and a scanning system for accelerating and focusing an electron beam 1 is mounted on top of a specimen chamber 13. A secondary electron detector 10 detects secondary electrons emanating from a specimen 4.

A controller 11 converts the output from the secondary electron detector 10 and the output from the voltage amplifier circuit 24 into image signals in synchronism with the scanning. The image signals are sent to the display portion 7. A computer including a personal computer can be used as the controller 11. A vacuum pumping system (not shown) and a specimen exchange chamber (not shown) are also mounted.

The operation of the charged-particle beam system constructed in this way is described now. The probes 2A and 2B are brought into contact with the opposite ends of the interconnect pattern 3 on the surface of the specimen 4. A desired region on the surface of the specimen 4 is scanned with the electron beam 1.

As a result of the scanning, secondary electrons 14 are produced from the surface of the specimen 4. At the same time, an absorption current flows through the interconnect pattern 3 formed on the specimen 4. The absorption current is detected by the probes 2A and 2B in contact with the pattern 3 and fed to the differential current-voltage converter 6. The converter 6 converts the difference between the currents detected at the probes into a voltage that is fed to the voltage amplifier circuit 24. The voltage is amplified by the amplifier circuit 24 and applied to the controller 11. The controller 11 converts the amplified voltage signal into an image signal in synchronism with the scanning of the beam, the image signal being sent to the display portion 7. As a result, an absorption current image of the interconnect pattern 3 is displayed on the display portion 7. In this way, according to the present embodiment, only in-phase components of the signal are removed by taking the difference between electrical currents detected by the probes 2A and 2B, respectively. Consequently, the differential component can be detected. At this time, if the signal path in the interconnect pattern 3 has a defective portion showing an abnormal resistance, the manner in which the electrical current is absorbed into the pattern 3 varies across the defective portion. Because the contrast of the absorption current image varies clearly across the defective portion A in the interconnect pattern, the defective portion A can be detected.

Meanwhile, where an electron image is displayed, the output signal from the secondary electron detector 10 is amplified by an amplifier (not shown) and fed to the controller 11. The controller 11 converts the detector output signal into an image signal in synchronism with the scanning. The image signal is fed to the display portion 7. As a result, a secondary electron beam of the interconnect pattern 3 is displayed on the display portion.

Alternatively, the secondary electron signal from the detector and the absorption electrical currents flowing through the probes 2A and 2B may be simultaneously fed to the controller 11. Both kinds of signals may be converted into image signals in synchronism with the electron beam scanning. A secondary electron image and an absorption current image of the same interconnect pattern may be simultaneously displayed on the display portion 7.

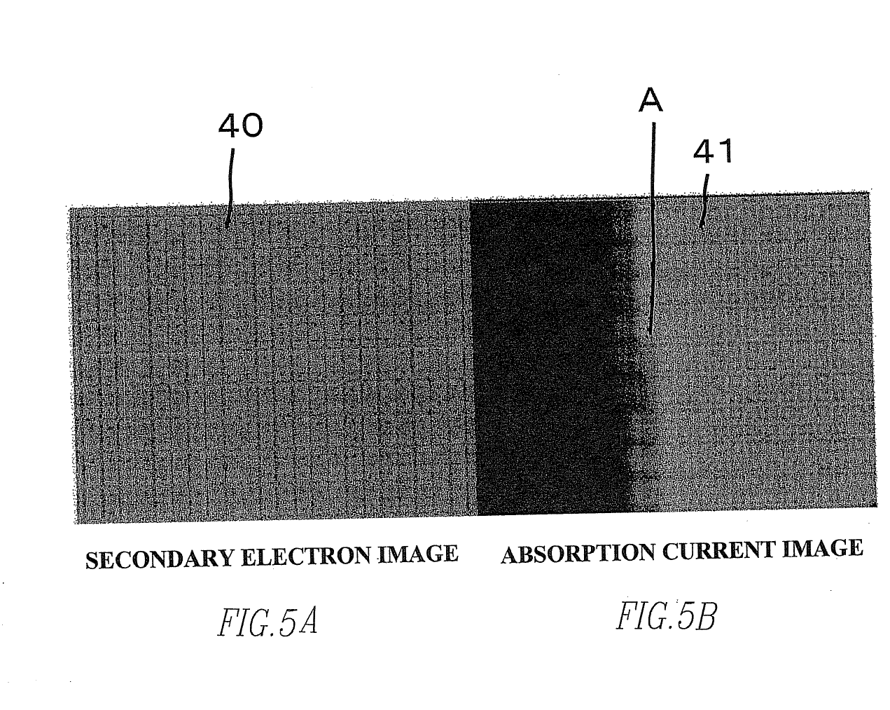

FIGS. 5A and 5B show a secondary electron image and an absorption current image which are displayed at the same time. In FIG. 5A, the secondary electron image is shown. Within this image, an interconnect pattern 40 is shown. In FIG. 5B, the absorption current image is shown. Within this image, an interconnect pattern 41 and a defective portion A are shown.

Where a secondary electron image and an absorption current image are displayed at the same time in this way, the defective portion can be identified from the absorption current image though the identification cannot be made from the secondary electron image. At the same time, the secondary electron image containing information about the surface of the specimen and the position of the defect can be collated.

Where a location on the interconnect pattern 3 to be analyzed is set, the electron beam 1 is scanned over the pattern 3, and secondary electrons 14 emanating from the pattern 3 are detected by the secondary electron detector 10. A secondary electron image of the interconnect pattern is displayed on the display device 7. The displayed image is observed, and the analyzed location is set. The probes 2A and 2B are brought into contact with the opposite ends of the set location on the interconnect pattern.

Where another location on the surface of the same specimen 4 is to be analyzed, the specimen stage 5 is moved to just under the objective lens of the electron optical column 9. An analysis is performed by a step similar to the aforementioned step for detecting the defective portion A.

The defective portion of the interconnect pattern 3 can be detected with high sensitivity by inserting a differentiator circuit between the differential current-voltage converter 6 and the controller 11 and feeding the differentiated output signal from the converter 6 to the controller 11.

### Second Embodiment

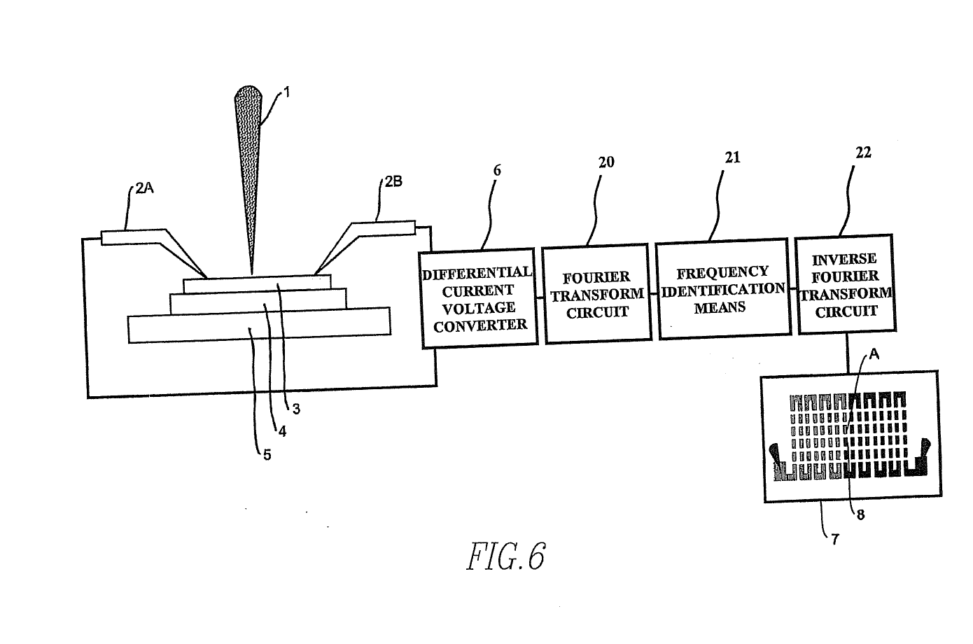

FIG. 6 is a diagram showing main portions of a charged-particle beam system according to another embodiment of the present invention. Those components of FIG. 6 which are identical with their counterparts of FIG. 1 are indicated by the same reference numerals as in FIG. 1.

A Fourier transform circuit 20 Fourier transforms the output signal from the differential current-voltage converter 6. A frequency identification means 21 identifies the frequencies of the output signal from the Fourier transform circuit 20. An inverse Fourier transform circuit 22 inverse Fourier transforms the output signal from the frequency identification means 21.

The operation of the system constructed in this way is described. The probes 2A and 2B are brought into contact with the opposite ends of the interconnect pattern 3 formed on the specimen 4 which, in turn, is placed on the specimen stage 5. Under this condition, the electron beam 1 is scanned over the surface of the specimen 4. An absorption current flows through the interconnect pattern 3.

The absorption current is detected by the probes 2A and 2B. The difference between the detected currents is converted into a voltage signal by the differential current-voltage converter 6. The voltage signal is supplied to the Fourier transform circuit 20, where the signal is decomposed into a continuous spectrum of frequency components.

The output from the Fourier transform circuit 20 is applied to the frequency identification means 21, where frequencies intrinsic to noise are removed. The output from the frequency identification means 21 is applied to the inverse Fourier transform circuit 22, where the signal is converted into an image signal. The image signal is fed to the display device 7. Consequently, an absorption current image from which noise has been removed can be obtained.

Having thus described my invention with the detail and particularity required by the Patent Laws, what is desired protected by Letters Patent is set forth in the following claims.

The invention claimed is:

1. A charged-particle beam system for displaying an image of a specimen on a display device by producing a charged-particle beam from a charged-particle beam source, scanning the beam in two dimensions over the specimen, and creating the image of the specimen based on a signal obtained from the specimen by the scanning, said charged-particle beam system comprising:
plural probing means having at least two probes which are brought into contact with arbitrary locations on the specimen; and
a differential current-voltage converter for converting a difference between absorption current signals obtained via the probing means into a voltage signal,
wherein said image of the specimen is created based on an output signal from the differential current-voltage converter and displayed on the display device.

2. A charged-particle beam system as set forth in claim 1, wherein there is further provided a differentiator circuit for differentiating the output signal from said differential current-voltage converter, and wherein said image of the specimen is created based on an output signal from said differentiator circuit and displayed on the display device.

3. A charged-particle beam system as set forth in claim 1, further including:
a Fourier transform device for Fourier transforming the output signal from said differential current-voltage converter;
frequency identification means for identifying frequencies of the Fourier transformed signal; and
an inverse Fourier transform circuit for inverse Fourier transforming an output signal from said frequency identification means,
wherein said image of the specimen is created based on an output signal from said inverse Fourier transform circuit and displayed on the display device.

4. A charged-particle beam system as set forth in claim 1, wherein said differential current-voltage converter includes an operational amplifier, a feedback resistor, and a second resistor inserted between a positive input terminal of the operational amplifier and ground.

5. A charged-particle beam system as set forth in any one of claims 1 to 4, wherein there is further provided a secondary electron detector for detecting secondary electrons emanating from the specimen, and wherein a specimen image created based on the detected secondary electrons and a specimen image created based on the output signal from said differential current-voltage converter are simultaneously displayed on the display device.
